(19) United States
(12) Patent Application Publication
(10) Pub. No.: US 2026/0094067 A1
(43) Pub. Date: Apr. 2, 2026

(54) TASK PROCESSING METHOD AND DEVICE

(71) Applicant: Lenovo (Beijing) Limited, Beijing (CN)

(72) Inventors: Haibo LIU, Beijing (CN); Xuan WANG, Beijing (CN); Gang DING, Beijing (CN)

(21) Appl. No.: 19/340,870

(22) Filed: Sep. 26, 2025

(30) Foreign Application Priority Data
Sep. 30, 2024 (CN) 202411391777.5

(51) Int. Cl. G06N 20/00

(52) U.S. Cl. CPC G06N 20/00

(57) ABSTRACT

A task processing method includes: in response to obtaining a target processing task, obtaining computing resource information of multiple processing units of an electronic device; and configuring first model weights of each of the multiple processing units based on the computing resource information, so that the multiple processing units synchronously execute the target processing task based on their respective first model weights.

### CROSS-REFERENCE TO RELATED APPLICATION(S)

This application claims priority to Chinese Patent Application No. 202411391777.5 filed on Sep. 30, 2024, which is incorporated herein by reference in its entirety.

### FIELD OF THE TECHNOLOGY

The present disclosure relates to a field of computer technology, and in particular to a task processing method and device.

### BACKGROUND

Certain electronic devices may be equipped with multiple processing units, such as CPU (Central Processing Unit), NPU (Neural Processing Unit), GPU (Graphic Processing Unit), or the like. There is a method of using multiple processing units to perform model inference to perform task processing. Under this method, each processing unit allocates fixed computing resources to participate in model inference. However, when the processing unit receives a new task, the performance may degrade due to insufficient available computing resources, thereby reducing the task processing efficiency.

### SUMMARY

In one aspect, a task processing method includes: in response to obtaining a target processing task, obtaining computing resource information of multiple processing units of an electronic device; and configuring first model weights of each of the multiple processing units based on the computing resource information, so that the multiple processing units synchronously execute the target processing task based on their respective first model weights.

In another aspect, the present disclosure provides an electronic device. The device includes: a memory storing computer program instructions; and a processor coupled to the memory and configured to execute the computer program instructions and perform: in response to obtaining a target processing task, obtaining computing resource information of multiple processing units of the electronic device; and configuring first model weights of each of the multiple processing units based on the computing resource information, so that the multiple processing units synchronously execute the target processing task based on their respective first model weights.

In yet another aspect, the present disclosure provides a non-transitory computer-readable storage medium storing computer program instructions executable by at least one processor to perform: in response to obtaining a target processing task, obtaining computing resource information of multiple processing units of an electronic device; and configuring first model weights of each of the multiple processing units based on the computing resource information, so that the multiple processing units synchronously execute the target processing task based on their respective first model weights.

### BRIEF DESCRIPTION OF THE DRAWINGS

To more clearly illustrate the technical solutions of the present disclosure, the following briefly describes the drawings for describing the embodiments. The drawings described below reflect certain embodiments described in the present disclosure. A person skilled in the technical field may derive other drawings based on these drawings without inventive effort.

FIG. 1 is a flowchart of a task processing method according to certain embodiments of the present disclosure;

FIG. 2 is a flowchart of obtaining computing resource information of multiple processing units of an electronic device according to certain embodiments of the present disclosure;

FIG. 3 is a flowchart of configuring a first model weight of each processing unit based on the computing resource information according to certain embodiments of the present disclosure;

FIG. 4 is a flowchart of configuring a model weight of the target processing model corresponding to the target processing task according to certain embodiments of the present disclosure;

FIG. 5 is a flowchart of configuring the model weight of the target processing model corresponding to the target processing task according to certain embodiments of the present disclosure;

FIG. 6 is a flowchart of multiple processing units synchronously executing the target processing task based on their respective first model weights according to certain embodiments of the present disclosure;

FIG. 7 is a flowchart of integrating the task processing results of each processing unit according to certain embodiments of the present disclosure;

FIG. 8 is a flowchart of determining a priority list according to certain embodiments of the present disclosure;

FIG. 9 is a flowchart of a task processing method according to certain embodiments of the present disclosure;

FIG. 10 is a schematic diagram of a principle of multiple processing units synchronously executing the target processing task according to certain embodiments of the present disclosure; and

FIG. 11 is a block diagram of a structure of a task processing device according to certain embodiments of the present disclosure.

### DETAILED DESCRIPTION

Various aspects and features of the present disclosure are described herein with reference to the accompanying drawings.

Various modifications may be made to certain embodiments of the present disclosure. Therefore, the foregoing description should not be construed as limiting, but merely as illustrative of embodiments. Other modifications within the scope and spirit of the present disclosure will occur to those skilled in the technical field.

The accompanying drawings, which are incorporated in and constitute a part of the present disclosure, illustrate certain embodiments of the present disclosure and, together with the general description of the present disclosure given above and the detailed description of the embodiments given below, serve to explain the principles of the present disclosure.

These and other features of the present disclosure become apparent from the following description of certain embodiments, which are given as non-limiting examples, with reference to the accompanying drawings.

Although the present disclosure has been described with reference to certain embodiments, those skilled in the technical field readily recognize that many other equivalent forms of the present disclosure are conceivable.

The foregoing and other aspects, features, and advantages of the present disclosure become more apparent from the following detailed description when taken in conjunction with the accompanying drawings.

Certain embodiments of the present disclosure are described hereinafter with reference to the accompanying drawings; however, the embodiments described are merely examples of the present disclosure, which may be embodied in various forms. Well-known and/or repetitive functions and structures are not described in detail to avoid obscuring the present disclosure with unnecessary or redundant details. Therefore, the structural and functional details disclosed herein are not intended to be limiting, but rather to serve as a basis and representative basis for the claims, to teach those skilled in the technical field to variously utilize the present disclosure with substantially any appropriate detailed structure.

The present disclosure may use the phrases “in certain embodiments” to refer to one or more of the same or different embodiments of the present disclosure.

A task processing method according to certain embodiments of the present disclosure configures first model weights for each processing unit based on computing resource information of multiple processing units in an electronic device, so that the multiple processing units synchronously execute a target processing task based on their respective first model weights. This allows each processing unit to execute the target processing task based on its own computing resources, thereby avoiding performance degradation of the processing unit and improving task processing efficiency.

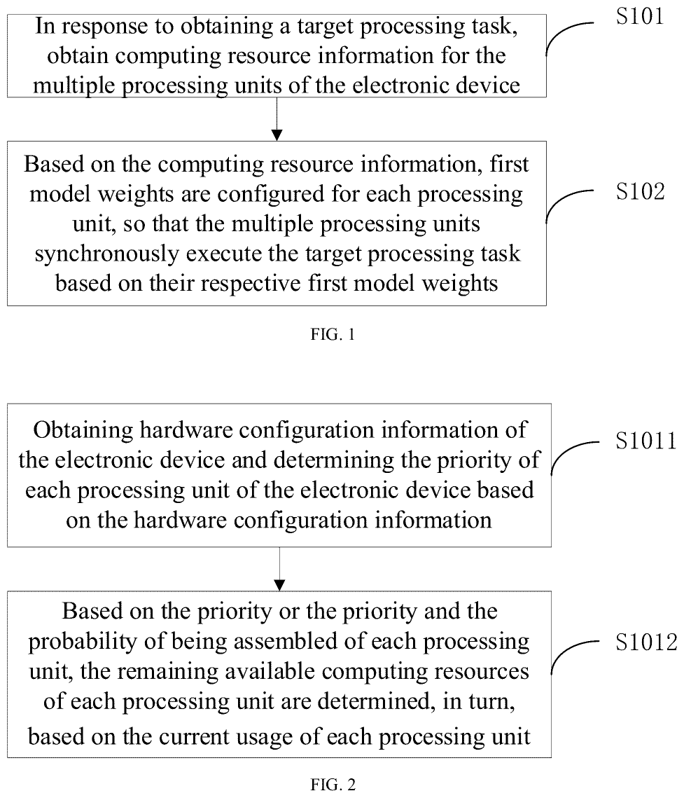

As shown in FIG. 1, the task processing method includes one or more of:
S101: In response to obtaining a target processing task, computing resource information for the multiple processing units of the electronic device is obtained.

In certain embodiments, the target processing task may be any task triggered by any application, such as an image generation task triggered by an image generation application, a video generation task triggered by a video generation application, or an image processing task, model training task, or image rendering task triggered by an image processing application. The electronic device is equipped with multiple processing units, and computing resource information for each of these processing units may be obtained based on computing power metrics. Examples of computing power metrics include TOPS (Tera Operations Per Second), FLOPS (Floating Point Operations Per Second), and MIPS (Million Instructions Per Second).

The processing unit may be at least one of a CPU, GPU, TPU (tensor processing unit), NPU, or APU (accelerated processing unit).

After obtaining the target processing task, the computing resources of each processing unit may be obtained. The total computing resources may be determined based on the sum of the individual computing resources. Computing resource information may then be determined based on the individual computing resources and the total computing resources.

For example, when the processing units are CPUs, GPUs, and TPUs, the TOPS of the CPU, GPU, and TPU may be determined separately. Computing resource information for the multiple processing units may be determined based on the TOPS of the CPU, GPU, and TPU, as well as the total TOPS.
S102: Based on the computing resource information, first model weights are configured for each processing unit, so that the multiple processing units synchronously execute the target processing task based on their respective first model weights.

In certain embodiments, model inference is performed by each processing unit to achieve synchronous execution of the target processing task. Based on each first model weight, the processing model corresponding to the target processing task may be assigned to each processing unit, enabling each processing unit to execute the target processing task.

Computing resource information may include the total computing resources of the electronic device and the computing resources of each processing unit. The first model weights for each processing unit may be configured based on the proportion of each processing unit's computing resources to the total computing resources of the electronic device. In certain embodiments, the task type of the target processing task may be considered. For example, more first model weights may be assigned to processing units more suitable for processing that task type to ensure more efficient task execution. When the target processing task type is image processing, more first model weights may be assigned to the GPU. When the target processing task type is model training, more first model weights may be assigned to the NPU. In certain embodiments, information about the tasks currently being executed by each processing unit may be considered. This task information may include the completion level of the current task. This completion level may be used to determine which processing unit should be assigned more first model weights. For example, a processing unit with a high completion level may be assigned more first model weights so that it may quickly execute the target processing task after completing its current task.

The target processing task may be divided into multiple subtasks based on the first model weights, with each processing unit executing each subtask, thereby achieving synchronous execution of the target processing task.

In certain embodiments of the present disclosure, a task processing method obtains computing resource information of multiple processing units of an electronic device in response to obtaining a target processing task; and configures first model weights for each processing unit based on the computing resource information, so that the multiple processing units synchronously execute the target processing task based on their respective first model weights. This allows each processing unit to execute the target processing task based on its own computing resource, avoiding performance degradation and improving task processing efficiency.

In certain embodiments of the present disclosure, the method includes one or more of:
Monitoring computing resource change information for each processing unit; and updating the first model weights configured for each processing unit based on the computing resource change information, so that the multiple processing units execute the target processing task based on updated second model weights;
Integrating the task processing results of each processing unit to obtain a target processing result.

In certain embodiments, the remaining computing resources of each processing unit may change due to changes in the executed task, such as the completion of the current task or the receipt of a new task. The computing resource changes of each processing unit may be monitored in real time or periodically (for example, every two seconds or every minute). This computing resource change information includes changes in total computing resources and changes in computing resources corresponding to each processing unit. Even when the total computing resources remain unchanged, the computing resources corresponding to each processing unit may still change. Based on this computing resource change information, the model weight distribution ratios of each processing unit are reconfigured, thereby updating the first model weights. New subtasks may be assigned to each processing unit using the updated second model weights, enabling each processing unit to synchronously execute the target processing task.

After multiple processing units synchronously execute the target processing task based on their respective first model weights, the task processing results of each processing unit are obtained and integrated to produce the target processing result. For example, when the target processing task is to generate an image, the task processing results of each processing unit may be the individual layers of the image, which are then spliced or fused to produce the target image. When the target processing task is to generate a video, the task processing results of each processing unit may be the individual frames of the video, which are then spliced or fused to produce the target video. When the target processing task is a text generation task, the task processing results of each processing unit may be texts, which are then merged to generate the target text.

The first model weights are updated based on changes in the computing resources of each processing unit, enabling flexible adjustment of the task volume executed by the processing unit, maintaining optimal performance and improving task processing efficiency. By integrating the task processing results of each processing unit, the accuracy of the target processing result is improved.

In certain embodiments of the present disclosure, obtaining computing resource information for multiple processing units of an electronic device, as shown in FIG. 2, includes one or more of:
S1011: Obtaining hardware configuration information of the electronic device and determining the priority of each processing unit of the electronic device based on the hardware configuration information.

In certain embodiments, the hardware configuration information may include the number of processing units in the electronic device, the type of processing unit, power supply configuration information, heat dissipation module configuration information, or the like. The hardware configuration information may be obtained based on information reported by each hardware component during initialization of the electronic device's boot program (for example, BIOS). The priority of each processing unit is determined based on the hardware configuration information. For example, the hardware configuration information includes the TOPS of the processing unit. The priority of each processing unit is determined according to the TOPS of the processing unit. In an implementation of the present disclosure, an initial priority list table may be established, as shown in Table 1.

TABLE 1

| Processing | TOPS | |
|---|---|---|
| Unit Type | Spec | Priority |
| dGPU | 60 | 0 |
| NPU | 45 | 1 |
| iGPU | 20 | 2 |
| CPU | 10 | 3 |

In Table 1, processing units include dGPU, NPU, iGPU, and CPU. Priority 0 is the highest and 3 is the lowest. The higher the priority, the greater the processing power.
S1012: Based on the priority or the priority and the probability of being assembled of each processing unit, the remaining available computing resources of each processing unit are determined, in turn, based on the current usage of each processing unit.

In certain embodiments, each processing unit has a corresponding amount of storage space. The higher the load on a processing unit, the less its remaining storage space. The current usage of each processing unit may include the current load of the processing unit and whether the processing unit is assembled. The remaining storage space of each processing unit may be determined in turn based on the priority and current usage of each processing unit, thereby determining the remaining available computing resources of each processing unit. The probability of being assembled of each processing unit may also be considered. For example, the probability of being assembled of the CPU is the highest, followed by the probability of being assembled of the iGPU, and then the probability of being assembled of the NPU. The remaining storage space of each processing unit is determined based on the priority, probability of being assembled of each processing unit, and current usage of each processing unit, thereby determining the remaining available computing resources of each processing unit.

The remaining available computing resources of each processing unit are determined based on the priority, or priority and probability of being assembled, of each processing unit, as well as the current usage of the processing unit. This helps ensure that the computing resource information reflects the actual situation of each processing unit, thereby improving the accuracy of the computing resource information.

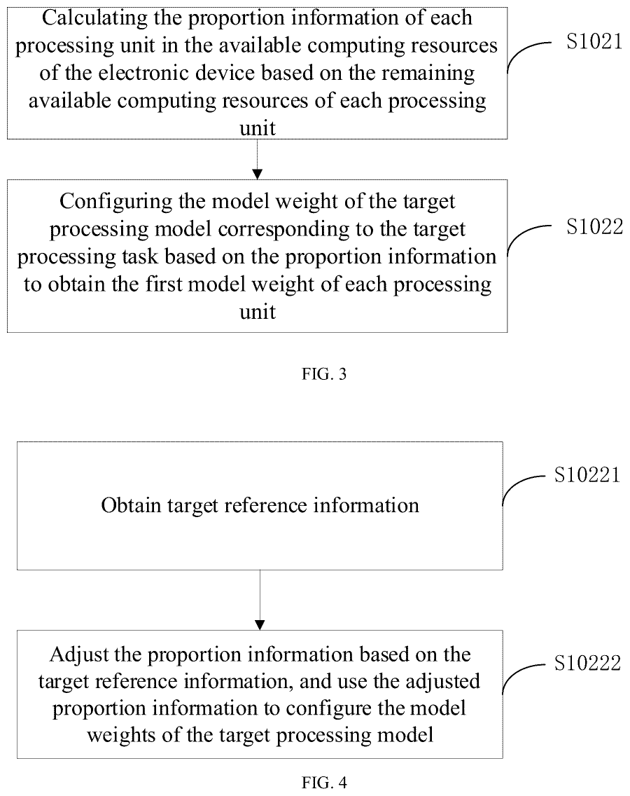

In certain embodiments of the present disclosure, configuring the first model weight of each processing unit based on the computing resource information, as shown in FIG. 3, includes one or more of:
S1021: Calculating the proportion information of each processing unit in the available computing resources of the electronic device based on the remaining available computing resources of each processing unit.

In certain embodiments, the available computing resources of the electronic device may be determined based on the remaining available computing resources of each processing unit. The corresponding proportion information is determined based on the proportion information of the remaining available computing resources of each processing unit to the available computing resources of the electronic device.
S1022: Configuring the model weight of the target processing model corresponding to the target processing task based on the proportion information to obtain the first model weight of each processing unit.

The target processing model, for example, a neural network model or a large model, may be divided based on the proportion information. The model weights of the target processing model may be configured to divide the target processing model into sub-models that may be loaded onto each processing unit. These sub-models may then be run on each processing unit to process the corresponding subtasks of the target processing task.

The model weights of the target processing model corresponding to the target processing task are configured based on the proportion information to obtain the first model weights of each processing unit, thereby more accurately determining the first model weights of each processing unit.

In certain embodiments of the present disclosure, configuring the model weights of the target processing model corresponding to the target processing task based on the proportion information, as shown in FIG. 4, includes one or more of:
S10221: Obtain target reference information.

In certain embodiments, the target reference information may be reference information related to the target processing task or reference information related to the processing unit. For example, the target reference information may include the task type, task completion level, and task update information of the task currently being processed by each processing unit of the electronic device, the current heat dissipation condition and power supply information of the electronic device, the spatial environment information of the electronic device, or communication connection information with other processing devices.
S10222: Adjust the proportion information based on the target reference information, and use the adjusted proportion information to configure the model weights of the target processing model.

The proportion information is first adjusted based on the target reference information to better reflect the actual situation of the target processing task or processing unit. The target processing model is then divided using the adjusted proportion information to obtain first model weights for each processing unit, thereby further improving the accuracy of each first model weight.

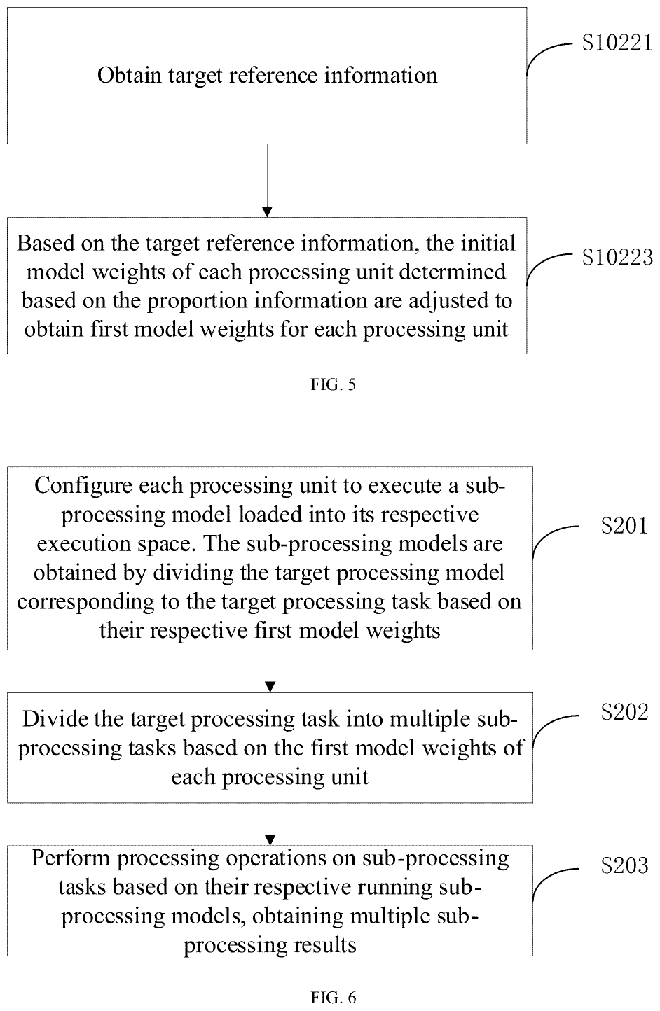

In certain embodiments of the present disclosure, the model weights of the target processing model corresponding to the target processing task are configured based on the proportion information, as shown in FIG. 5, including one or more of:
S10221: Obtain target reference information.

In certain embodiments, the target reference information may be reference information related to the target processing task or reference information related to the processing unit.
S10223: Based on the target reference information, the initial model weights of each processing unit determined based on the proportion information are adjusted to obtain first model weights for each processing unit.

In certain embodiments, the target processing model is first divided based on the proportion information to determine initial model weights for each processing unit. These initial model weights are then adjusted based on the target reference information to obtain first model weights for each processing unit. This helps ensure that the first model weights better align with the actual conditions of the target processing task or processing unit, thereby further improving the accuracy of each first model weight.

In certain embodiments of the present disclosure, configuring the model weights of the target processing model corresponding to the target processing task based on the proportion information includes one or more of:
Obtaining priority information for each processing unit, and configuring the model weights of the target processing model based on the priority information and the proportion information;
Obtaining target task information for the target processing task, and configuring the model weights of the target processing model based on the target task information and the proportion information;
Obtaining current task information for each processing unit, and configuring the model weights of the target processing model based on the current task information and the proportion information.

In certain embodiments, the target reference information may be the priority information of each processing unit, which is determined by the hardware configuration information of the electronic device. The proportion information may be adjusted based on the priority information, and then the target processing model may be divided based on the adjusted proportion information to determine the first model weight for each processing unit. In certain embodiments, the target processing model may be divided based on the proportion information to determine the initial model weight for each processing unit, and then the initial model weights may be adjusted based on the priority information of each processing unit to obtain the first model weight, thereby further improving the accuracy of the first model weight. For example, when the iGPU has a higher priority, the proportion information corresponding to the iGPU may be increased, and then the first model weight of the iGPU may be determined based on the increased proportion information. This allows more processing tasks to be assigned to the higher-priority iGPU. In certain embodiments, an initial model weight may be determined based on the iGPU's proportion information, and then the initial model weight may be increased based on the iGPU's priority, thereby allowing more processing tasks to be assigned to the higher-priority iGPU.

The target reference information may also be target task information for the target processing task. This target task information may include one or more of the target task's task type, task priority, task urgency, and task requirement information. The task type determines which processing unit is most suitable, while the task priority and task urgency determine which processing units should take on more processing tasks. The task requirement information may, for example, specify a specific processing unit to perform task processing. The proportion information may be adjusted based on the target task information, and then the target processing model may be divided based on the adjusted proportion information to determine the first model weights for each processing unit. In certain embodiments, the target processing model may be divided based on the proportion information to determine the initial model weights for each processing unit, and then the initial model weights may be adjusted based on the target task information of each processing unit to obtain the first model weights, thereby further improving the accuracy of the first model weights.

For example, when the target processing task is an image processing task and the GPU is more suitable for image processing, the proportion information or the initial model weights may be adjusted to assign the GPU more processing tasks. When the target processing task is a model training task, which the NPU is more suited to, the NPU may be assigned more processing tasks by adjusting the proportion information or the initial model weights. When the target processing task has a higher priority or urgency, and the CPU and GPU are assigned to handle high-priority or high-urgency tasks, the CPU and GPU may be assigned more processing tasks by adjusting the proportion information or the initial model weights. When the target processing task is assigned to the CPU and NPU, the CPU and NPU may be assigned more processing tasks by adjusting the proportion information or the initial model weights.

The target reference information may also be the current task information of each processing unit. This current task information may include the priority of the current processing task (whether processing may be paused or deferred), the completion percentage (after completion, consideration may be given to assigning more model weight), and other information. The proportion information may be adjusted based on the current task information, and the target processing model may be divided based on the adjusted proportion information to determine the first model weights for each processing unit. In certain embodiments, the target processing model may be divided based on the proportion information to determine the initial model weights for each processing unit, and then the initial model weights may be adjusted based on the current task information of each processing unit to obtain the first model weights, thereby further improving the accuracy of the first model weights.

For example, when the CPU's current processing task has a higher priority, the proportion information or the initial model weights may be adjusted to reduce the CPU's processing tasks. When the GPU's current processing task has a lower priority and may be paused, the proportion information or the initial model weights may be adjusted to allow the GPU to take on more processing tasks. When the completion percentage of the CPU's current processing task is high, the proportion information or the initial model weights may be adjusted to allow the CPU to take on more processing tasks corresponding to the target processing task after completing the current task.

In certain embodiments of the present disclosure, when the priority of a processing unit's current processing task is higher than a target priority, or the computing resource utilization rate caused by a processing unit's current processing task reaches a target utilization rate (for example, 80%), the processing unit is designated as a target processing unit that does not participate in processing the target task, thereby ensuring the reliable execution of the current processing task or the reliability of the processing unit.

In certain embodiments, at least two pieces of the priority information of each processing unit, the target task information of the target processing task, and the current task information of each processing unit may be used to adjust the proportion information or the initial model weights, thereby making the first model weights more consistent with the actual conditions of the processing unit and the target processing task, thereby improving the accuracy of the first model weights.

In certain embodiments of the present disclosure, the multiple processing units synchronously execute the target processing task based on their respective first model weights, as shown in FIG. 6, including one or more of:
S201: Configure each processing unit to execute a sub-processing model loaded into its respective execution space. The sub-processing models are obtained by dividing the target processing model corresponding to the target processing task based on their respective first model weights.

In certain embodiments, the execution space may be memory space provided by each processing unit. Based on the first model weights, the target processing model corresponding to the target processing task is divided into multiple sub-processing models, each corresponding to a processing unit. Each sub-processing model is then loaded into the memory space of the corresponding processing unit, causing the processing unit to execute the sub-processing model loaded into its own memory space.
S202: Divide the target processing task into multiple sub-processing tasks based on the first model weights of each processing unit.

The target processing task is split into multiple sub-processing tasks based on the first model weights. For example, when the target processing task is an image generation task, each sub-processing task may generate sub-images corresponding to different regions of the image or generate different layers of the image. When the target processing task is a video generation task, each sub-processing task may generate one or more corresponding video frames. When the target processing task is a model training task, each sub-processing task may complete model inference for different layers or nodes of the model to be trained. The same word processing task may correspond to one layer or multiple layers of the model to be trained.
S203: Configure the multiple processing units to perform processing operations on corresponding sub-processing tasks based on their respective running sub-processing models, obtaining multiple sub-processing results.

In certain embodiments, each processing unit is configured to perform model inference based on its respective running sub-processing model to perform processing operations on the corresponding sub-processing task, obtaining multiple sub-processing results. For example, when the target processing task is an image generation task, the multiple sub-processing results correspond to sub-images of various regions of the target image, or to different layers of the target image. When the target processing task is a video generation task, the multiple sub-processing results correspond to one or more corresponding video frames. When the target processing task is image rendering, the multiple sub-processing results correspond to rendering results at different rendering stages.

By configuring the multiple processing units to perform processing operations on corresponding sub-processing tasks based on their respective running sub-processing models, task processing efficiency is improved.

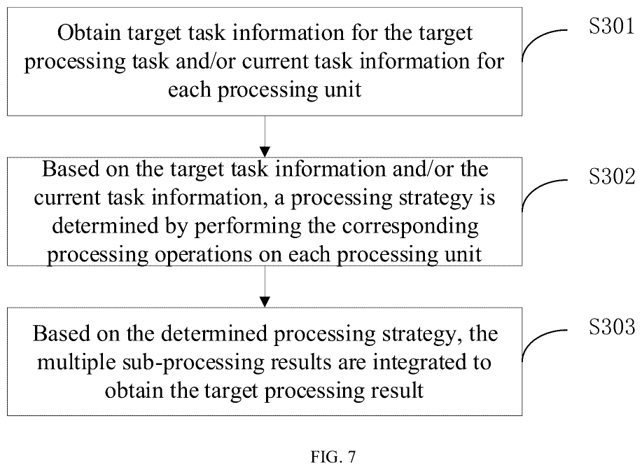

In certain embodiments of the present disclosure, the multiple processing units synchronously execute the target processing task based on their respective first model weights, as shown in FIG. 7, including the following steps:
S301: Obtain target task information for the target processing task and/or current task information for each processing unit.

In certain embodiments, the target task information may include one or more of the target task's task type, task priority, task urgency, and task requirement information. The task type determines which processing unit is most suitable, while the task priority and task urgency determine which processing units should take on more processing tasks. Task requirement information may, for example, specify a specific processing unit to perform task processing. Current task information for each processing unit may include the priority of the current processing task (whether processing may be paused or delayed), the completion percentage (after completion, consideration may be given to assigning more model weight), and other information.
S302: Based on the target task information and/or the current task information, a processing strategy is determined for the multiple sub-processing results obtained by performing the corresponding processing operations on each processing unit.

In certain embodiments, the target task information primarily considers different task types or generated content types to determine the integration strategy for the multiple sub-processing results, such as whether to use splicing, interpolation, fusion, summarization, or padding. For example, when the task type is image generation, splicing or fusion may be used. When the task type is model training, fusion may be used. The current task information is primarily used to determine which processor performs the fusion processing operation, primarily based on the idle/busy status of each processing unit. For example, when the CPU's current load is high and the GPU's load is low, the GPU may be used as the processing unit for the fusion processing.
S303: Based on the determined processing strategy, the multiple sub-processing results are integrated to obtain the target processing result.

In certain embodiments, based on the determined processing strategy, the multiple processing results are integrated using the corresponding processing unit in the corresponding integration method. For example, the GPU may perform the splicing and fusion processing of the multiple sub-images. The CPU may integrate model inference results of the various processing units to obtain a final inference result.

In certain embodiments of the present disclosure, the method includes:

In response to obtaining information about a change in the communication connection between the electronic device and the target processing device, updating the model weights configured for each processing unit based on the communication connection change information, so that the electronic device and the multiple processing units of the target processing device perform the target processing task based on their respective configured model weights.

In certain embodiments, the electronic device and the target processing device may collaborate to perform the target processing task. The target processing device may also include multiple processing units. A communication connection exists between the electronic device and the target processing device. The communication connection change information includes the establishment or disconnection of a connection. When a connection is established, the target processing device shares some processing tasks, reducing the processing tasks of the electronic device. The model weights of some processing units (such as the CPU) in the electronic device may be reduced, allowing these processing units to perform other tasks. When the communication connection between the electronic device and the target processing device is disconnected, the electronic device assumes the entire target processing task. The model weights of some processing units with higher processing performance (such as the CPU and GPU) may need to be increased to ensure efficient execution of the target processing task.

To further illustrate the technical concept of the present disclosure, the technical solution of the present disclosure is described in conjunction with certain implementation scenarios.

Certain embodiments of the present disclosure provide a task processing method, where the processing units of an electronic device include a CPU, an iGPU, a dGPU, and an NPU.

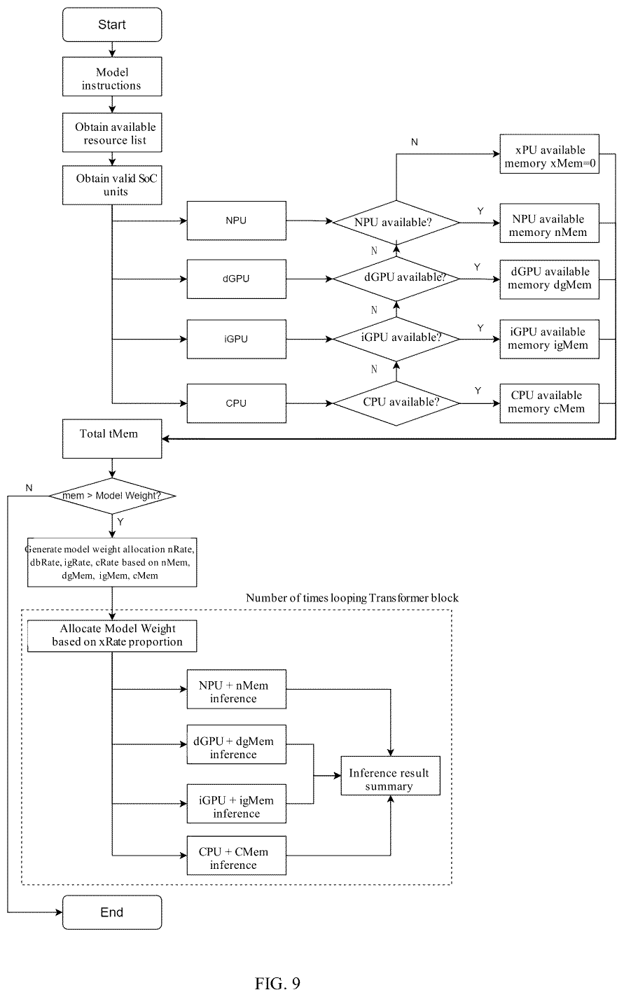

With reference to FIG. 9, the task processing method includes one or more of:
S1: Receive a model instruction.

The model instruction is a model inference instruction for a target processing model corresponding to a target processing task.

Before S1, a static priority list of the CPU, iGPU, dGPU, and NPU is first determined, as shown in Table 1.
S2: Obtain a list of currently available system resources.

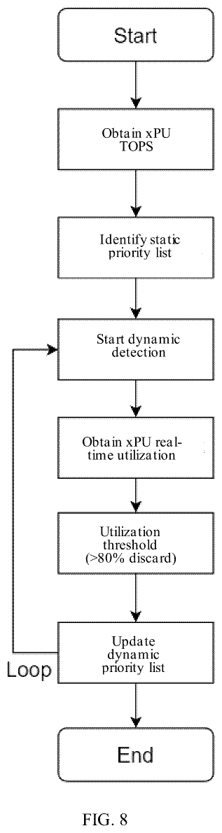

As shown in FIG. 8, the TOPS of the xPU (for example, the CPU, iGPU, dGPU, and NPU) is first obtained, and then the static priority list shown in Table 1 is calibrated. After obtaining the static priority list, dynamic detection is initiated. The real-time utilization of the xPU is obtained, and a dynamic priority list is determined based on the utilization and the TOPS in the static priority list. When the utilization of a processing unit exceeds 80%, that processing unit is not used for task processing. Dynamic detection may be performed every 2 seconds to update the currently available system resource list.

An example of a dynamic priority list may be shown in Table 2.

TABLE 2

| SoC | Utilization Rate | |
|---|---|---|
| Type | (%) | Priority |
| NPU | 10 | 0 |
| CPU | 50 | 1 |
| dGPU | 80 | 2 |
| iGPU | 80 | 3 |

As shown in Table 2, the NPU has the highest priority, followed by the CPU. The utilization of the dGPU and iGPU is 80%, so it is advisable to exclude them from task processing.
S3: Obtain the effective SoC units.

The effective SoC units represent the remaining available computing resources of each processing unit. When the CPU, iGPU, dGPU, and NPU are all available, the remaining available computing resources of each processing unit is determined based on the available memory capacity of the CPU, iGPU, dGPU, and NPU. The available memory capacities of the CPU, iGPU, dGPU, and NPU are represented by cMem, igMem, dgMem, and nMem, respectively.
S4: Determine the remaining total available memory capacity tMem.

$$cMem + igMem + dgMem + nMem = tMem .$$

S5: Compare the remaining total available memory capacity tMem with the capacity Model Weight of the target processing model. When tMem>Model Weight, proceed to S6. Otherwise, terminate.
S6: Determine the weight allocation ratios (for example, the weights of each first model) nRate, igRate, dgRate, and nRate based on the respective proportions of cMem, igMem, dgMem, and nMem in tMem.
S7: Divide the target processing model into multiple sub-processing models based on nRate, igRate, dgRate, and nRate, and load each sub-processing model onto the CPU, iGPU, dGPU, and NPU.
S8: Divide the target processing task into multiple sub-processing tasks based on nRate, igRate, dgRate, and nRate.
S9: Configure the CPU, iGPU, dGPU, and NPU to perform processing operations on the corresponding sub-processing tasks based on their respective running sub-processing models, thereby obtaining multiple sub-inference results.

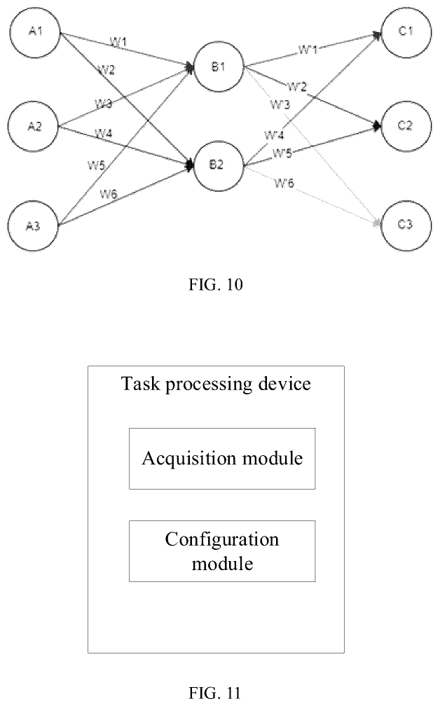

In certain embodiments, the target processing model includes multiple layers, each of which utilizes multiple processing units for inference. As shown in FIG. 10, the CPU may perform calculations on nodes B1 and C1, the iGPU may perform calculations on nodes B2 and C2, and the dGPU may perform calculations on node C3.
S10: Integrate the results of each sub-inference to obtain a single overall inference result.
S11: The target processing model may include multiple looping inference processes. By looping through S7-S10, the inference result corresponding to the target processing task is obtained.

Certain embodiments of the present disclosure provide a task processing device, as shown in FIG. 11, including: an acquisition module for obtaining computing resource information of multiple processing units of an electronic device in response to obtaining a target processing task; and a configuration module for configuring first model weights for each processing unit based on the computing resource information, so that the multiple processing units synchronously execute the target processing task based on their respective first model weights.

In one embodiment, the system includes: an update module configured to monitor computing resource changes of each processing unit and, based on the computing resource change information, update the first model weights configured for each processing unit so that the multiple processing units execute the target processing task based on the updated second model weights; and an integration module configured to integrate the task processing results of each processing unit to obtain the target processing result.

In one embodiment, the acquisition module is configured to: obtain hardware configuration information of the electronic device and, based on the hardware configuration information, determine the priority of each processing unit of the electronic device; and, based on the priority or the priority and the probability of being assembled of each processing unit, determine the remaining available computing resources of each processing unit based on the current usage of each processing unit.

In one embodiment, the configuration module is configured to: calculate the proportion information of each processing unit to the available computing resources of the electronic device based on the remaining available computing resources of each processing unit; and configure the model weight of the target processing model corresponding to the target processing task based on the proportion information to obtain a first model weight for each processing unit.

In one embodiment, the configuration module is configured to: obtain target reference information; adjust the proportion information based on the target reference information to configure the model weight of the target processing model using the adjusted proportion information; or, adjust the initial model weight of each processing unit determined based on the proportion information based on the target reference information to obtain the first model weight for each processing unit.

In one embodiment, the configuration module is configured to perform one or more of: obtaining priority information of each processing unit and configuring the model weight of the target processing model based on the priority information and the proportion information; obtaining target task information of the target processing task and configuring the model weight of the target processing model based on the target task information and the proportion information; obtaining current task information of each processing unit and configuring the model weight of the target processing model based on the current task information and the proportion information.

In one embodiment, the configuration module includes an execution module configured to: configure each processing unit to execute a sub-processing model loaded into its respective execution space, where the sub-processing model is obtained by dividing the target processing model corresponding to the target processing task based on its respective first model weight; divide the target processing task into multiple sub-processing tasks based on the first model weight of each processing unit; and configure each of the multiple processing units to execute processing operations on the corresponding sub-processing tasks based on the sub-processing models executed, thereby obtaining multiple sub-processing results.

In one embodiment, the integration module is configured to: obtain target task information for a target processing task and/or current task information for each processing unit; determine, based on the target task information and/or current task information, a processing strategy for multiple sub-processing results obtained by executing corresponding processing operations on each processing unit; and integrate the multiple sub-processing results based on the determined processing strategy to obtain a target processing result.

In one embodiment, the update module is configured to: in response to obtaining information about a change in the communication connection between the electronic device and the target processing device, update the model weights configured for each processing unit based on the communication connection change information, so that the multiple processing units of the electronic device and the target processing device perform the target processing task based on their configured model weights.

The above embodiments may be implemented in whole or in part via software, hardware, firmware, or any combination thereof. When implemented using software, they may be implemented in whole or in part in the form of a computer program product. The computer program product includes one or more computer instructions. When loaded and executed on a computer, the computer program instructions fully or partially generate the processes or functions described in the embodiments of the present disclosure. The computer may be a general-purpose computer, a special-purpose computer, a computer network, or other programmable device. The computer instructions may be stored in a computer-readable storage medium or transmitted from one computer-readable storage medium to another. For example, the computer instructions may be transmitted from one website, computer, server, or data center to another website, computer, server, or data center via wired (for example, coaxial cable, optical fiber, digital subscriber line) or wireless (for example, infrared, wireless, microwave, or the like) means. The computer-readable storage medium may be any available medium accessible by a computer or a data storage device such as a server or data center that integrates one or more available media. The available medium may be a magnetic medium (for example, a floppy disk, hard disk, or magnetic tape), an optical medium (for example, a DVD), or a semiconductor medium (for example, a solid-state drive).

The above embodiments are exemplary embodiments of the present disclosure and are not intended to limit the present disclosure. The scope of protection of the present disclosure is defined by the claims. Persons skilled in the technical field may make various modifications or equivalent substitutions to the present disclosure within the spirit and scope of protection of the present disclosure, and such modifications or equivalent substitutions shall be deemed to fall within the scope of protection of the present disclosure.

What is claimed is:

1. A task processing method, comprising:
in response to obtaining a target processing task, obtaining computing resource information of multiple processing units of an electronic device; and
configuring first model weights of each of the multiple processing units based on the computing resource information, so that the multiple processing units synchronously execute the target processing task based on their respective first model weights.

2. The method of claim 1, further comprising one or more of:
monitoring computing resource change information of each of the multiple processing units, and updating the first model weights based on the computing resource change information to obtain second model weights, so that the multiple processing units execute the target processing task based on the second model weights; and
integrating task processing results of each of the multiple processing units to obtain a target processing result.

3. The method of claim 1, wherein obtaining computing resource information for multiple processing units includes:
obtaining hardware configuration information of the electronic device, and determining a priority of each of the multiple processing units of the electronic device based on the hardware configuration information; and
determining remaining available computing resource of each of the multiple processing units based on the priority or based on the priority and probability of being assembled of each of the multiple processing units.

4. The method of claim 1, wherein configuring the first model weights of each of the multiple processing units includes:
calculating proportion information of each of the multiple processing units in available computing resources of the electronic device based on remaining available computing resources of each of the multiple processing units;
configuring a model weight of a target processing model corresponding to the target processing task based on the proportion information, thereby obtaining the first model weights of each of the multiple processing units.

5. The method of claim 4, wherein configuring the model weight of the target processing model corresponding to the target processing task based on the proportion information includes:
obtaining target reference information; and adjusting the proportion information based on the target reference information, thereby configuring the model weight of the target processing model using the adjusted proportion information;
or,
adjusting an initial model weight of each of the multiple processing units determined based on the proportion information, thereby obtaining the first model weight of each processing unit.

6. The method of claim 5, wherein configuring the model weight of the target processing model corresponding to the target processing task based on the proportion information includes one or more of:
obtaining priority information of each of the multiple processing units and configuring the model weight of the target processing model based on the priority information and the proportion information;
obtaining target task information of the target processing task and configuring the model weight of the target processing model based on the target task information and the proportion information; and
obtaining current task information of each of the multiple processing units and configuring the model weight of the target processing model based on the current task information and the proportion information.

7. The method of claim 1, wherein the multiple processing units synchronously execute the target processing task based on their respective first model weights includes:
configuring each of the multiple processing units to execute a sub-processing model loaded into its respective execution space, wherein the sub-processing model is obtained by dividing the target processing model corresponding to the target processing task based on its respective first model weights;
dividing the target processing task into multiple sub-processing tasks based on the first model weights of each of the multiple processing units; and
configuring the multiple processing units to execute processing operations on the corresponding sub-processing tasks based on their respective executed sub-processing models, thereby obtaining multiple sub-processing results.

8. The method of claim 2, wherein integrating the task processing results of each of the multiple processing units includes:
obtaining target task information of a target processing task and/or current task information of each of the multiple processing units;
determining, based on the target task information and/or current task information, a processing strategy for multiple sub-processing results obtained by performing corresponding processing operations on each of the multiple processing units; and
integrating the multiple sub-processing results based on the processing strategy to obtain a target processing result.

9. The method of claim 1, further comprising:
in response to obtaining communication connection change information between the electronic device and a target processing device, updating the model weights configured for each of the multiple processing units based on the communication connection change information, so that the multiple processing units of the electronic device and the target processing device perform the target processing task based on their respective configured model weights.

10. An electronic device, comprising: a memory storing computer program instructions; and a processor coupled to the memory and configured to execute the computer program instructions and perform:
in response to obtaining a target processing task, obtaining computing resource information of multiple processing units of the electronic device; and
configuring first model weights of each of the multiple processing units based on the computing resource information, so that the multiple processing units synchronously execute the target processing task based on their respective first model weights.

11. The electronic device of claim 10, wherein the processor is further configured to perform one or more of:
monitoring computing resource change information of each of the multiple processing units, and updating the first model weights based on the computing resource change information to obtain second model weights, so that the multiple processing units execute the target processing task based on the second model weights; and
integrating task processing results of each of the multiple processing units to obtain a target processing result.

12. The electronic device of claim 10, wherein obtaining computing resource information for multiple processing units includes:
obtaining hardware configuration information of the electronic device, and determining a priority of each of the multiple processing units of the electronic device based on the hardware configuration information; and
determining remaining available computing resource of each of the multiple processing units based on the priority or based on the priority and probability of being assembled of each of the multiple processing units.

13. The electronic device of claim 10, wherein configuring the first model weights of each of the multiple processing units includes:
calculating proportion information of each of the multiple processing units in available computing resources of the electronic device based on remaining available computing resources of each of the multiple processing units;
configuring a model weight of a target processing model corresponding to the target processing task based on the proportion information, thereby obtaining the first model weights of each of the multiple processing units.

14. The electronic device of claim 13, wherein configuring the model weight of the target processing model corresponding to the target processing task based on the proportion information includes:
obtaining target reference information; and adjusting the proportion information based on the target reference information, thereby configuring the model weight of the target processing model using the adjusted proportion information;
or,
adjusting an initial model weight of each of the multiple processing units determined based on the proportion information, thereby obtaining the first model weight of each processing unit.

15. The electronic device of claim 14, wherein configuring the model weight of the target processing model corresponding to the target processing task based on the proportion information includes one or more of:
obtaining priority information of each of the multiple processing units and configuring the model weight of the target processing model based on the priority information and the proportion information;
obtaining target task information of the target processing task and configuring the model weight of the target processing model based on the target task information and the proportion information; and
obtaining current task information of each of the multiple processing units and configuring the model weight of the target processing model based on the current task information and the proportion information.

16. The electronic device of claim 10, wherein the multiple processing units synchronously execute the target processing task based on their respective first model weights includes:
configuring each of the multiple processing units to execute a sub-processing model loaded into its respective execution space, wherein the sub-processing model is obtained by dividing the target processing model corresponding to the target processing task based on its respective first model weights;
dividing the target processing task into multiple sub-processing tasks based on the first model weights of each of the multiple processing units; and
configuring the multiple processing units to execute processing operations on the corresponding sub-processing tasks based on their respective executed sub-processing models, thereby obtaining multiple sub-processing results.

17. The electronic device of claim 11, wherein integrating the task processing results of each of the multiple processing units includes:
obtaining target task information of a target processing task and/or current task information of each of the multiple processing units;
determining, based on the target task information and/or current task information, a processing strategy for multiple sub-processing results obtained by performing corresponding processing operations on each of the multiple processing units; and
integrating the multiple sub-processing results based on the processing strategy to obtain a target processing result.

18. The electronic device of claim 10, wherein the processor is further configured to perform:
in response to obtaining communication connection change information between the electronic device and a target processing device, updating the model weights configured for each of the multiple processing units based on the communication connection change information, so that the multiple processing units of the electronic device and the target processing device perform the target processing task based on their respective configured model weights.

19. A non-transitory computer-readable storage medium storing computer program instructions executable by at least one processor to perform:
in response to obtaining a target processing task, obtaining computing resource information of multiple processing units of an electronic device; and
configuring first model weights of each of the multiple processing units based on the computing resource information, so that the multiple processing units synchronously execute the target processing task based on their respective first model weights.

20. The non-transitory computer-readable storage medium of claim 19, wherein the computer program instructions are further executable by the at least one processor to perform one or more of:
monitoring computing resource change information of each of the multiple processing units, and updating the first model weights based on the computing resource change information to obtain second model weights, so that the multiple processing units execute the target processing task based on the second model weights; and
integrating task processing results of each of the multiple processing units to obtain a target processing result.
